(19) United States
(12) Patent Application Publication
(10) Pub. No.: US 2021/0333392 A1
(43) Pub. Date: Oct. 28, 2021

(54) SOUND WAVE DETECTION DEVICE AND ARTIFICIAL INTELLIGENT ELECTRONIC DEVICE HAVING THE SAME

(71) Applicant: LG ELECTRONICS INC., Seoul (KR)

(72) Inventor: Donghoon YI, Seoul (KR)

(73) Assignee: LG ELECTRONICS INC., Seoul (KR)

(21) Appl. No.: 16/485,232

(22) PCT Filed: Jun. 13, 2019
(86) PCT No.: PCT/KR2019/007149

§ 371 Date: Aug. 12, 2019

(51) Int. Cl. G01S 15/87; G06N 3/02

(52) U.S. Cl. CPC G01S 15/87; G06N 3/02

(57) ABSTRACT

Disclosed is a sound wave detection device including a signal generator for generating a plurality of sound wave signals having different frequencies; a transmitter for transmitting the plurality of sound wave signals; a receiver for receiving an echoed sound wave signal among the sound wave signals; and a controller for emitting a first sound wave signal of the plurality of sound wave signals and transmitting a second sound wave signal having a frequency different from that of the first sound wave signal through the transmitter in a search period of the first sound wave signal, wherein the search period is a value obtained by dividing a value obtained by doubling a maximum detection distance by a sound speed.

### TECHNICAL FIELD

The present invention relates to a sound wave detection device having a reduced search period and an autonomous vehicle having the same.

### BACKGROUND ART

As communication technology develops, artificial intelligent electronic devices, for example, robot cleaners, in which electronic devices recognize and operate a periphery thereof, have been developed, and even in the case of a vehicle, research on autonomous vehicles that recognize and drive peripheral objects without a driver is actively being carried out.

One of typical methods for detecting a periphery of an autonomous vehicle for autonomous driving is a method using a sound wave, and a typical device for detecting an object using a sound wave is, for example, sonar. Passive sonar detects a noise emitted from a target in the water or active sonar transmits a sound wave pulse and receives and analyzes a return signal reflected from a target at a random distance to detect the target.

In a conventional single frequency active sound wave detection method, there is a disadvantage that a pulse signal modulated about a single center frequency is emitted and the signal cannot be detected during a time (2R/c, c is a sound speed) in which the signal is propagated up to a maximum distance R to be detected and is returned. Therefore, when a detection distance becomes longer, a time that cannot be detected, i.e., a search period T becomes longer, and when a detection object shows a large position change within a short time, there is a problem that temporal and spatial positions of the detection object are undersampled.

In a conventional multi-frequency active sound wave detection method, by almost simultaneously emitting pulse signals modulated about a plurality of center frequencies, a scattering frequency characteristic of a detection object may be measured. However, because the conventional multi-frequency active sound wave detection method is basically the same as the above-described single frequency active sound wave method, there is a problem that temporal and spatial positions of a detection object may be undersampled.

### DISCLOSURE

### Technical Problem

The present invention has been made in view of such a technical background and provides a sound wave detection device having a reduced search period.

The present invention further provides an autonomous vehicle in which a sound wave detection device having a reduced search period is installed.

### Technical Solution

In an embodiment of the present invention, there is provided a sound wave detection device including a signal generator for generating a plurality of sound wave signals having different frequencies; a transmitter for transmitting the plurality of sound wave signals; a receiver for receiving an echoed sound wave signal among the sound wave signals; and a controller for emitting a first sound wave signal of the plurality of sound wave signals and transmitting a second sound wave signal having a frequency different from that of the first sound wave signal through the transmitter in a search period of the first sound wave signal, wherein the search period is a value obtained by dividing a value obtained by doubling a maximum detection distance by a sound speed.

The first sound wave signal may have a center frequency of a first frequency band, and the second sound wave signal may have a center frequency of a second frequency band that does not overlap with the first frequency band.

The number of the plurality of sound wave signals may be n, the n number of sound wave signals may have different frequencies, and the controller may transmit each of the n number of sound wave signals to correspond to a period in which the search period is divided into 1/n.

In another embodiment of the present invention, there is provided an electronic device in which artificial intelligence is installed, and include a sound wave detection unit for detecting a peripheral object with a sound wave, wherein the sound wave detection unit includes a signal generation module for generating a plurality of sound wave signals having different frequencies; a transmission module for transmitting the plurality of sound wave signals; a reception module for receiving an echoed sound wave signal among the sound wave signals; and a control module for emitting a first sound wave signal of the plurality of sound wave signals and transmitting a second sound wave signal having a frequency different from that of the first sound wave signal through the transmitter in a search period of the first sound wave signal, wherein the search period is a value obtained by dividing a value obtained by doubling a maximum detection distance by a sound speed.

### Advantageous Effects

According to an embodiment of the present invention, because a plurality of sound wave signals whose frequencies do not overlap are transmitted and a peripheral object is detected through an echoed sound wave signal, a search period is short and thus a blind state can be effectively reduced.

Further, according to the present invention, because peripheral objects are recognized using sound waves, animals sensitive to a sound can be prevented from colliding with autonomous driving electronic devices.

### DESCRIPTION OF DRAWINGS

FIG. 1 is a block diagram of a wireless communication system to which methods proposed in the present specification may be applied.

FIG. 2 is a diagram illustrating an example of a signal transmitting/receiving method in a wireless communication system.

FIG. 3 illustrates an example of a basic operation of a user terminal and a 5G network in a 5G communication system.

FIG. 4 is a block diagram of a sound wave detection device according to an embodiment of the present invention.

FIGS. 5 and 6 are diagrams illustrating a sound wave signal used in a sound wave detection device.

FIG. 6 is a diagram illustrating a vehicle according to an embodiment of the present invention.

FIG. 7 is a block diagram of an AI device according to an embodiment of the present invention.

FIG. 8 is a diagram illustrating a system in which an autonomous vehicle and an AI device are connected according to an embodiment of the present invention.

The accompanying drawings, which are included to provide a further understanding of the invention and are incorporated in and constitute a part of the specification, illustrate embodiments of the invention and, together with the description, serve to explain the technical features of the invention.

### MODE FOR INVENTION

Hereinafter, embodiments of the present invention will be described in detail with reference to the attached drawings, and the same reference numbers are used throughout the drawings to refer to the same or like parts. In the following description, suffixes “module” and “unit” may be given to components in consideration of only facilitation of description and do not have meanings or functions discriminated from each other. Further, detailed descriptions of well-known functions and structures incorporated herein may be omitted to avoid obscuring the subject matter of the present invention. Further, the attached drawings are provided to easily understand embodiments disclosed in this specification and the technical spirit disclosed in the present specification is not limited by the attached drawings, and it is to be understood that the invention is intended to cover all modifications, equivalents, and alternatives falling within the spirit and scope of the invention.

Terms including an ordinal number such as a “first” and “second” may be used for describing various elements, and the above-described elements are not limited by the above terms. The terms are used for distinguishing one element from another element.

When it is described that an element is “connected” or “electrically connected” to another element, the element may be “directly connected” or “directly electrically connected” to the other element or may be “connected” or “electrically connected” to the other element through a third element. However, when it is described that an element is “directly connected” or “directly electrically connected” to another element, no element may exist between the element and the other elements.

Unless the context otherwise clearly indicates, words used in the singular include the plural, the plural includes the singular.

Further, in the present invention, a term “comprise” or “have” indicates presence of a characteristic, numeral, step, operation, element, component, or combination thereof described in a specification and does not exclude presence or addition of at least one other characteristic, numeral, step, operation, element, component, or combination thereof.

Hereinafter, a device requiring AI processed information and/or 5th generation mobile communication (5G communication) requiring an AI processor will be described in a paragraph A to a paragraph G.

### A. Example of Block Diagram of UE and 5G Network

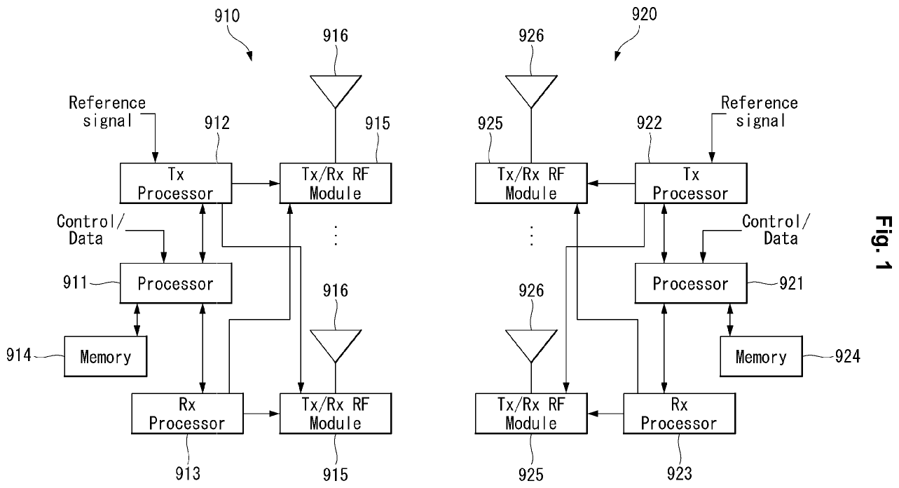

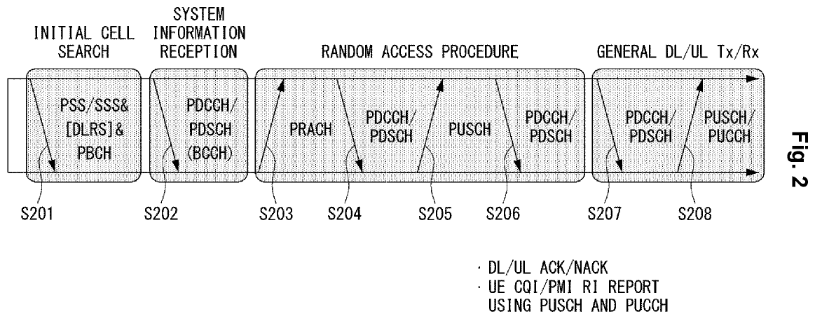

FIG. 1 is a block diagram of a wireless communication system to which methods proposed in the disclosure are applicable.

Referring to FIG. 1, a device (autonomous device) including an autonomous module is defined as a first communication device (910 of FIG. 1), and a processor 911 can perform detailed autonomous operations.

A 5G network including another vehicle communicating with the autonomous device is defined as a second communication device (920 of FIG. 1), and a processor 921 can perform detailed autonomous operations.

The 5G network may be represented as the first communication device and the autonomous device may be represented as the second communication device.

For example, the first communication device or the second communication device may be a base station, a network node, a transmission terminal, a reception terminal, a wireless device, a wireless communication device, an autonomous device, or the like.

For example, the first communication device or the second communication device may be a base station, a network node, a transmission terminal, a reception terminal, a wireless device, a wireless communication device, a vehicle, a vehicle having an autonomous function, a connected car, a drone (Unmanned Aerial Vehicle, UAV), and AI (Artificial Intelligence) module, a robot, an AR (Augmented Reality) device, a VR (Virtual Reality) device, an MR (Mixed Reality) device, a hologram device, a public safety device, an MTC device, an IoT device, a medical device, a Fin Tech device (or financial device), a security device, a climate/environment device, a device associated with 5G services, or other devices associated with the fourth industrial revolution field.

For example, a terminal or user equipment (UE) may include a cellular phone, a smart phone, a laptop computer, a digital broadcast terminal, personal digital assistants (PDAs), a portable multimedia player (PMP), a navigation device, a slate PC, a tablet PC, an ultrabook, a wearable device (e.g., a smartwatch, a smart glass and a head mounted display (HMD)), etc. For example, the HMD may be a display device worn on the head of a user. For example, the HMD may be used to realize VR, AR or MR. For example, the drone may be a flying object that flies by wireless control signals without a person therein. For example, the VR device may include a device that implements objects or backgrounds of a virtual world. For example, the AR device may include a device that connects and implements objects or background of a virtual world to objects, backgrounds, or the like of a real world. For example, the MR device may include a device that unites and implements objects or background of a virtual world to objects, backgrounds, or the like of a real world. For example, the hologram device may include a device that implements 360-degree 3D images by recording and playing 3D information using the interference phenomenon of light that is generated by two lasers meeting each other which is called holography. For example, the public safety device may include an image repeater or an imaging device that can be worn on the body of a user. For example, the MTC device and the IoT device may be devices that do not require direct interference or operation by a person. For example, the MTC device and the IoT device may include a smart meter, a bending machine, a thermometer, a smart bulb, a door lock, various sensors, or the like. For example, the medical device may be a device that is used to diagnose, treat, attenuate, remove, or prevent diseases. For example, the medical device may be a device that is used to diagnose, treat, attenuate, or correct injuries or disorders. For example, the medial device may be a device that is used to examine, replace, or change structures or functions. For example, the medical device may be a device that is used to control pregnancy. For example, the medical device may include a device for medical treatment, a device for operations, a device for (external) diagnose, a hearing aid, an operation device, or the like. For example, the security device may be a device that is installed to prevent a danger that is likely to occur and to keep safety. For example, the security device may be a camera, a CCTV, a recorder, a black box, or the like. For example, the Fin Tech device may be a device that can provide financial services such as mobile payment.

Referring to FIG. 1, the first communication device 910 and the second communication device 920 include processors 911 and 921, memories 914 and 924, one or more Tx/Rx radio frequency (RF) modules 915 and 925, Tx processors 912 and 922, Rx processors 913 and 923, and antennas 916 and 926. The Tx/Rx module is also referred to as a transceiver. Each Tx/Rx module 915 transmits a signal through each antenna 926. The processor implements the aforementioned functions, processes and/or methods. The processor 921 may be related to the memory 924 that stores program code and data. The memory may be referred to as a computer-readable medium. More specifically, the Tx processor 912 implements various signal processing functions with respect to L1 (i.e., physical layer) in DL (communication from the first communication device to the second communication device). The Rx processor implements various signal processing functions of L1 (i.e., physical layer).

UL (communication from the second communication device to the first communication device) is processed in the first communication device 910 in a way similar to that described in association with a receiver function in the second communication device 920. Each Tx/Rx module 925 receives a signal through each antenna 926. Each Tx/Rx module provides RF carriers and information to the Rx processor 923. The processor 921 may be related to the memory 924 that stores program code and data. The memory may be referred to as a computer-readable medium.

### B. Signal Transmission/Reception Method in Wireless Communication System

FIG. 2 is a diagram showing an example of a signal transmission/reception method in a wireless communication system.

Referring to FIG. 2, when a UE is powered on or enters a new cell, the UE performs an initial cell search operation such as synchronization with a BS (S201). For this operation, the UE can receive a primary synchronization channel (P-SCH) and a secondary synchronization channel (S-SCH) from the BS to synchronize with the BS and acquire information such as a cell ID. In LTE and NR systems, the P-SCH and S-SCH are respectively called a primary synchronization signal (PSS) and a secondary synchronization signal (SSS). After initial cell search, the UE can acquire broadcast information in the cell by receiving a physical broadcast channel (PBCH) from the BS. Further, the UE can receive a downlink reference signal (DL RS) in the initial cell search step to check a downlink channel state. After initial cell search, the UE can acquire more detailed system information by receiving a physical downlink shared channel (PDSCH) according to a physical downlink control channel (PDCCH) and information included in the PDCCH (S202).

Meanwhile, when the UE initially accesses the BS or has no radio resource for signal transmission, the UE can perform a random access procedure (RACH) for the BS (steps S203 to S206). To this end, the UE can transmit a specific sequence as a preamble through a physical random access channel (PRACH) (S203 and S205) and receive a random access response (RAR) message for the preamble through a PDCCH and a corresponding PDSCH (S204 and S206). In the case of a contention-based RACH, a contention resolution procedure may be additionally performed.

After the UE performs the above-described process, the UE can perform PDCCH/PDSCH reception (S207) and physical uplink shared channel (PUSCH)/physical uplink control channel (PUCCH) transmission (S208) as normal uplink/downlink signal transmission processes. Particularly, the UE receives downlink control information (DCI) through the PDCCH. The UE monitors a set of PDCCH candidates in monitoring occasions set for one or more control element sets (CORESET) on a serving cell according to corresponding search space configurations. A set of PDCCH candidates to be monitored by the UE is defined in terms of search space sets, and a search space set may be a common search space set or a UE-specific search space set. CORESET includes a set of (physical) resource blocks having a duration of one to three OFDM symbols. A network can configure the UE such that the UE has a plurality of CORESETs. The UE monitors PDCCH candidates in one or more search space sets. Here, monitoring means attempting decoding of PDCCH candidate(s) in a search space. When the UE has successfully decoded one of PDCCH candidates in a search space, the UE determines that a PDCCH has been detected from the PDCCH candidate and performs PDSCH reception or PUSCH transmission on the basis of DCI in the detected PDCCH. The PDCCH can be used to schedule DL transmissions over a PDSCH and UL transmissions over a PUSCH. Here, the DCI in the PDCCH includes downlink assignment (i.e., downlink grant (DL grant)) related to a physical downlink shared channel and including at least a modulation and coding format and resource allocation information, or an uplink grant (UL grant) related to a physical uplink shared channel and including a modulation and coding format and resource allocation information.

An initial access (IA) procedure in a 5G communication system will be additionally described with reference to FIG. 2.

The UE can perform cell search, system information acquisition, beam alignment for initial access, and DL measurement on the basis of an SSB. The SSB is interchangeably used with a synchronization signal/physical broadcast channel (SS/PBCH) block.

The SSB includes a PSS, an SSS and a PBCH. The SSB is configured in four consecutive OFDM symbols, and a PSS, a PBCH, an SSS/PBCH or a PBCH is transmitted for each OFDM symbol. Each of the PSS and the SSS includes one OFDM symbol and 127 subcarriers, and the PBCH includes 3 OFDM symbols and 576 subcarriers.

Cell search refers to a process in which a UE acquires time/frequency synchronization of a cell and detects a cell identifier (ID) (e.g., physical layer cell ID (PCI)) of the cell. The PSS is used to detect a cell ID in a cell ID group and the SSS is used to detect a cell ID group. The PBCH is used to detect an SSB (time) index and a half-frame.

There are 336 cell ID groups and there are 3 cell IDs per cell ID group. A total of 1008 cell IDs are present. Information on a cell ID group to which a cell ID of a cell belongs is provided/acquired through an SSS of the cell, and information on the cell ID among 336 cell ID groups is provided/acquired through a PSS.

The SSB is periodically transmitted in accordance with SSB periodicity. A default SSB periodicity assumed by a UE during initial cell search is defined as 20 ms. After cell access, the SSB periodicity can be set to one of {5 ms, 10 ms, 20 ms, 40 ms, 80 ms, 160 ms} by a network (e.g., a BS).

Next, acquisition of system information (SI) will be described.

SI is divided into a master information block (MIB) and a plurality of system information blocks (SIBs). SI other than the MIB may be referred to as remaining minimum system information. The MIB includes information/parameter for monitoring a PDCCH that schedules a PDSCH carrying SIB1 (SystemInformationBlock1) and is transmitted by a BS through a PBCH of an SSB. SIB1 includes information related to availability and scheduling (e.g., transmission periodicity and SI-window size) of the remaining SIBs (hereinafter, SIBx, x is an integer equal to or greater than 2). SiBx is included in an SI message and transmitted over a PDSCH. Each SI message is transmitted within a periodically generated time window (i.e., SI-window).

A random access (RA) procedure in a 5G communication system will be additionally described with reference to FIG. 2.

A random access procedure is used for various purposes. For example, the random access procedure can be used for network initial access, handover, and UE-triggered UL data transmission. A UE can acquire UL synchronization and UL transmission resources through the random access procedure. The random access procedure is classified into a contention-based random access procedure and a contention-free random access procedure. A detailed procedure for the contention-based random access procedure is as follows.

A UE can transmit a random access preamble through a PRACH as Msg1 of a random access procedure in UL. Random access preamble sequences having different two lengths are supported. A long sequence length 839 is applied to subcarrier spacings of 1.25 kHz and 5 kHz and a short sequence length 139 is applied to subcarrier spacings of 15 kHz, 30 kHz, 60 kHz and 120 kHz.

When a BS receives the random access preamble from the UE, the BS transmits a random access response (RAR) message (Msg2) to the UE. A PDCCH that schedules a PDSCH carrying a RAR is CRC masked by a random access (RA) radio network temporary identifier (RNTI) (RA-RNTI) and transmitted. Upon detection of the PDCCH masked by the RA-RNTI, the UE can receive a RAR from the PDSCH scheduled by DCI carried by the PDCCH. The UE checks whether the RAR includes random access response information with respect to the preamble transmitted by the UE, that is, Msg1. Presence or absence of random access information with respect to Msg1 transmitted by the UE can be determined according to presence or absence of a random access preamble ID with respect to the preamble transmitted by the UE. If there is no response to Msg1, the UE can retransmit the RACH preamble less than a predetermined number of times while performing power ramping. The UE calculates PRACH transmission power for preamble retransmission on the basis of most recent pathloss and a power ramping counter.

The UE can perform UL transmission through Msg3 of the random access procedure over a physical uplink shared channel on the basis of the random access response information. Msg3 can include an RRC connection request and a UE ID. The network can transmit Msg4 as a response to Msg3, and Msg4 can be handled as a contention resolution message on DL. The UE can enter an RRC connected state by receiving Msg4.

### C. Beam Management (BM) Procedure of 5G Communication System

A BM procedure can be divided into (1) a DL MB procedure using an SSB or a CSI-RS and (2) a UL BM procedure using a sounding reference signal (SRS). In addition, each BM procedure can include Tx beam swiping for determining a Tx beam and Rx beam swiping for determining an Rx beam.

The DL BM procedure using an SSB will be described.

Configuration of a beam report using an SSB is performed when channel state information (CSI)/beam is configured in RRC_CONNECTED.
A UE receives a CSI-ResourceConfig IE including CSI-SSB-ResourceSetList for SSB resources used for BM from a BS. The RRC parameter “csi-SSB-ResourceSetList” represents a list of SSB resources used for beam management and report in one resource set. Here, an SSB resource set can be set as {SSBx1, SSBx2, SSBx3, SSBx4, . . . }. An SSB index can be defined in the range of 0 to 63.
The UE receives the signals on SSB resources from the BS on the basis of the CSI-SSB-ResourceSetList.
When CSI-RS reportConfig with respect to a report on SSBRI and reference signal received power (RSRP) is set, the UE reports the best SSBRI and RSRP corresponding thereto to the BS. For example, when reportQuantity of the CSI-RS reportConfig IE is set to ‘ssb-Index-RSRP’, the UE reports the best SSBRI and RSRP corresponding thereto to the BS.

When a CSI-RS resource is configured in the same OFDM symbols as an SSB and ‘QCL-TypeD’ is applicable, the UE can assume that the CSI-RS and the SSB are quasi co-located (QCL) from the viewpoint of ‘QCL-TypeD’. Here, QCL-TypeD may mean that antenna ports are quasi co-located from the viewpoint of a spatial Rx parameter. When the UE receives signals of a plurality of DL antenna ports in a QCL-TypeD relationship, the same Rx beam can be applied.

Next, a DL BM procedure using a CSI-RS will be described.

An Rx beam determination (or refinement) procedure of a UE and a Tx beam swiping procedure of a BS using a CSI-RS will be sequentially described. A repetition parameter is set to ‘ON’ in the Rx beam determination procedure of a UE and set to ‘OFF’ in the Tx beam swiping procedure of a BS.

First, the Rx beam determination procedure of a UE will be described.
The UE receives an NZP CSI-RS resource set IE including an RRC parameter with respect to ‘repetition’ from a BS through RRC signaling. Here, the RRC parameter ‘repetition’ is set to ‘ON’.
The UE repeatedly receives signals on resources in a CSI-RS resource set in which the RRC parameter ‘repetition’ is set to ‘ON’ in different OFDM symbols through the same Tx beam (or DL spatial domain transmission filters) of the BS.
The UE determines an RX beam thereof.
The UE skips a CSI report. That is, the UE can skip a CSI report when the RRC parameter ‘repetition’ is set to ‘ON’.

Next, the Tx beam determination procedure of a BS will be described.
A UE receives an NZP CSI-RS resource set IE including an RRC parameter with respect to ‘repetition’ from the BS through RRC signaling. Here, the RRC parameter ‘repetition’ is related to the Tx beam swiping procedure of the BS when set to ‘OFF’.
The UE receives signals on resources in a CSI-RS resource set in which the RRC parameter ‘repetition’ is set to ‘OFF’ in different DL spatial domain transmission filters of the BS.
The UE selects (or determines) a best beam.
The UE reports an ID (e.g., CRI) of the selected beam and related quality information (e.g., RSRP) to the BS. That is, when a CSI-RS is transmitted for BM, the UE reports a CRI and RSRP with respect thereto to the BS.

Next, the UL BM procedure using an SRS will be described.
A UE receives RRC signaling (e.g., SRS-Config IE) including a (RRC parameter) purpose parameter set to ‘beam management” from a BS. The SRS-Config IE is used to set SRS transmission. The SRS-Config IE includes a list of SRS-Resources and a list of SRS-ResourceSets. Each SRS resource set refers to a set of SRS-resources.

The UE determines Tx beamforming for SRS resources to be transmitted on the basis of SRS-SpatialRelation Info included in the SRS-Config IE. Here, SRS-SpatialRelation Info is set for each SRS resource and indicates whether the same beamforming as that used for an SSB, a CSI-RS or an SRS will be applied for each SRS resource.
When SRS-SpatialRelationInfo is set for SRS resources, the same beamforming as that used for the SSB, CSI-RS or SRS is applied. However, when SRS-SpatialRelationInfo is not set for SRS resources, the UE arbitrarily determines Tx beamforming and transmits an SRS through the determined Tx beamforming.

Next, a beam failure recovery (BFR) procedure will be described.

In a beamformed system, radio link failure (RLF) may frequently occur due to rotation, movement or beamforming blockage of a UE. Accordingly, NR supports BFR in order to prevent frequent occurrence of RLF. BFR is similar to a radio link failure recovery procedure and can be supported when a UE knows new candidate beams. For beam failure detection, a BS configures beam failure detection reference signals for a UE, and the UE declares beam failure when the number of beam failure indications from the physical layer of the UE reaches a threshold set through RRC signaling within a period set through RRC signaling of the BS. After beam failure detection, the UE triggers beam failure recovery by initiating a random access procedure in a PCell and performs beam failure recovery by selecting a suitable beam. (When the BS provides dedicated random access resources for certain beams, these are prioritized by the UE). Completion of the aforementioned random access procedure is regarded as completion of beam failure recovery.

### D. URLLC (Ultra-Reliable and Low Latency Communication)

URLLC transmission defined in NR can refer to (1) a relatively low traffic size, (2) a relatively low arrival rate, (3) extremely low latency requirements (e.g., 0.5 and 1 ms), (4) relatively short transmission duration (e.g., 2 OFDM symbols), (5) urgent services/messages, etc. In the case of UL, transmission of traffic of a specific type (e.g., URLLC) needs to be multiplexed with another transmission (e.g., eMBB) scheduled in advance in order to satisfy more stringent latency requirements. In this regard, a method of providing information indicating preemption of specific resources to a UE scheduled in advance and allowing a URLLC UE to use the resources for UL transmission is provided.

NR supports dynamic resource sharing between eMBB and URLLC. eMBB and URLLC services can be scheduled on non-overlapping time/frequency resources, and URLLC transmission can occur in resources scheduled for ongoing eMBB traffic. An eMBB UE may not ascertain whether PDSCH transmission of the corresponding UE has been partially punctured and the UE may not decode a PDSCH due to corrupted coded bits. In view of this, NR provides a preemption indication. The preemption indication may also be referred to as an interrupted transmission indication.

With regard to the preemption indication, a UE receives DownlinkPreemption IE through RRC signaling from a BS. When the UE is provided with DownlinkPreemption IE, the UE is configured with INT-RNTI provided by a parameter int-RNTI in DownlinkPreemption IE for monitoring of a PDCCH that conveys DCI format 2_1. The UE is additionally configured with a corresponding set of positions for fields in DCI format 2_1 according to a set of serving cells and positionInDCI by INT-ConfigurationPerServing Cell including a set of serving cell indexes provided by servingCellID, configured having an information payload size for DCI format 2_1 according to dci-Payloadsize, and configured with indication granularity of time-frequency resources according to timeFrequencySect.

The UE receives DCI format 2_1 from the BS on the basis of the DownlinkPreemption IE.

When the UE detects DCI format 2_1 for a serving cell in a configured set of serving cells, the UE can assume that there is no transmission to the UE in PRBs and symbols indicated by the DCI format 2_1 in a set of PRBs and a set of symbols in a last monitoring period before a monitoring period to which the DCI format 2_1 belongs. For example, the UE assumes that a signal in a time-frequency resource indicated according to preemption is not DL transmission scheduled therefor and decodes data on the basis of signals received in the remaining resource region.

E. mMTC (Massive MTC)

mMTC (massive Machine Type Communication) is one of 5G scenarios for supporting a hyper-connection service providing simultaneous communication with a large number of UEs. In this environment, a UE intermittently performs communication with a very low speed and mobility. Accordingly, a main goal of mMTC is operating a UE for a long time at a low cost. With respect to mMTC, 3GPP deals with MTC and NB (NarrowBand)-IoT.

mMTC has features such as repetitive transmission of a PDCCH, a PUCCH, a PDSCH (physical downlink shared channel), a PUSCH, etc., frequency hopping, retuning, and a guard period.

That is, a PUSCH (or a PUCCH (particularly, a long PUCCH) or a PRACH) including specific information and a PDSCH (or a PDCCH) including a response to the specific information are repeatedly transmitted. Repetitive transmission is performed through frequency hopping, and for repetitive transmission, (RF) retuning from a first frequency resource to a second frequency resource is performed in a guard period and the specific information and the response to the specific information can be transmitted/received through a narrowband (e.g., 6 resource blocks (RBs) or 1 RB).

### F. Basic Operation Between Autonomous Vehicles Using 5G Communication

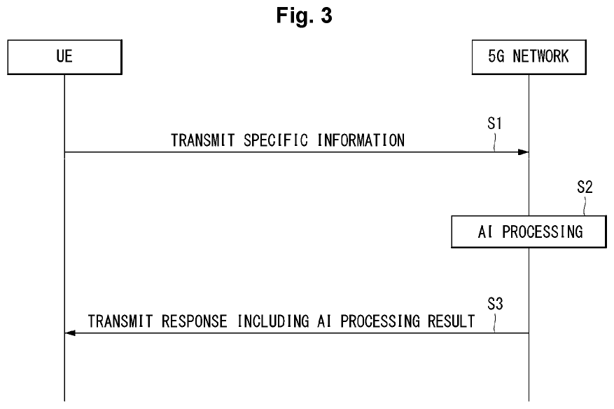

FIG. 3 shows an example of basic operations of an autonomous vehicle and a 5G network in a 5G communication system.

The autonomous vehicle transmits specific information to the 5G network (S1). The specific information may include autonomous driving related information. In addition, the 5G network can determine whether to remotely control the vehicle (S2). Here, the 5G network may include a server or a module which performs remote control related to autonomous driving. In addition, the 5G network can transmit information (or signal) related to remote control to the autonomous vehicle (S3).

### G. Applied Operations Between Autonomous Vehicle and 5G Network in 5G Communication System

Hereinafter, the operation of an autonomous vehicle using 5G communication will be described in more detail with reference to wireless communication technology (BM procedure, URLLC, mMTC, etc.) described in FIGS. 1 and 2.

First, a basic procedure of an applied operation to which a method proposed by the present invention which will be described later and eMBB of 5G communication are applied will be described.

As in steps S1 and S3 of FIG. 3, the autonomous vehicle performs an initial access procedure and a random access procedure with the 5G network prior to step S1 of FIG. 3 in order to transmit/receive signals, information and the like to/from the 5G network.

More specifically, the autonomous vehicle performs an initial access procedure with the 5G network on the basis of an SSB in order to acquire DL synchronization and system information. A beam management (BM) procedure and a beam failure recovery procedure may be added in the initial access procedure, and quasi-co-location (QCL) relation may be added in a process in which the autonomous vehicle receives a signal from the 5G network.

In addition, the autonomous vehicle performs a random access procedure with the 5G network for UL synchronization acquisition and/or UL transmission. The 5G network can transmit, to the autonomous vehicle, a UL grant for scheduling transmission of specific information. Accordingly, the autonomous vehicle transmits the specific information to the 5G network on the basis of the UL grant. In addition, the 5G network transmits, to the autonomous vehicle, a DL grant for scheduling transmission of 5G processing results with respect to the specific information. Accordingly, the 5G network can transmit, to the autonomous vehicle, information (or a signal) related to remote control on the basis of the DL grant.

Next, a basic procedure of an applied operation to which a method proposed by the present invention which will be described later and URLLC of 5G communication are applied will be described.

As described above, an autonomous vehicle can receive DownlinkPreemption IE from the 5G network after the autonomous vehicle performs an initial access procedure and/or a random access procedure with the 5G network. Then, the autonomous vehicle receives DCI format 2_1 including a preemption indication from the 5G network on the basis of DownlinkPreemption IE. The autonomous vehicle does not perform (or expect or assume) reception of eMBB data in resources (PRBs and/or OFDM symbols) indicated by the preemption indication. Thereafter, when the autonomous vehicle needs to transmit specific information, the autonomous vehicle can receive a UL grant from the 5G network.

Next, a basic procedure of an applied operation to which a method proposed by the present invention which will be described later and mMTC of 5G communication are applied will be described.

Description will focus on parts in the steps of FIG. 3 which are changed according to application of mMTC.

In step S1 of FIG. 3, the autonomous vehicle receives a UL grant from the 5G network in order to transmit specific information to the 5G network. Here, the UL grant may include information on the number of repetitions of transmission of the specific information and the specific information may be repeatedly transmitted on the basis of the information on the number of repetitions. That is, the autonomous vehicle transmits the specific information to the 5G network on the basis of the UL grant. Repetitive transmission of the specific information may be performed through frequency hopping, the first transmission of the specific information may be performed in a first frequency resource, and the second transmission of the specific information may be performed in a second frequency resource. The specific information can be transmitted through a narrowband of 6 resource blocks (RBs) or 1 RB.

The above-described 5G communication technology can be combined with methods proposed in the present invention which will be described later and applied or can complement the methods proposed in the present invention to make technical features of the methods concrete and clear.

Before describing an autonomous vehicle based on the above-described 5G communication technology, a sound wave detection device according to an embodiment of the present invention is first described, and an autonomous vehicle is described in which a sound wave detection device is installed.

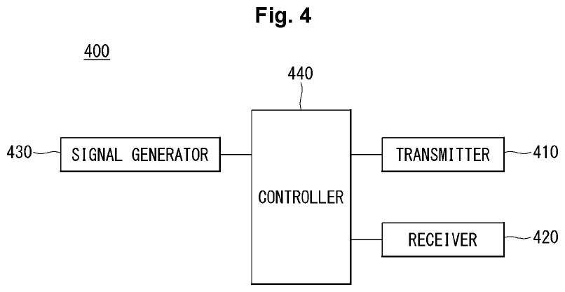

Hereinafter, a configuration of a sound wave detection device according to an embodiment is described in more detail with reference to FIG. 4. FIG. 4 is a block diagram illustrating a configuration of a sound wave detection device.

A sound wave detection device 400 may include a transmitter 410 for emitting a sound wave signal, a receiver 420 for receiving an echoed sound wave signal, a signal generator 430 for generating a sound wave signal, and a control module 440 for controlling an operation of each module and emitting a first sound wave signal among a plurality of sound wave signals and transmitting a second sound wave signal having a frequency different from that of the first sound wave signal within a search period of the first sound wave signal through the transmitter.

First, the transmitter 410 is configured to transmit a sound wave signal having a direction angle to the outside of the vehicle, and in a preferable form, the transmitter 410 may be a speaker. Sound wave signals emitted through the transmitter 410 preferably have directivity and are emitted and in an example, sound wave signals may be emitted in a driving direction of the vehicle.

The receiver 420 is configured to receive a sound wave signal echoed by colliding to an object among sound wave signals emitted through the transmitter 410.

The signal generator 430 generates the n number of sound wave signals under the control of the controller, and then number of sound wave signals may be generated with different frequencies. Here, different frequencies may mean that the respective frequencies are not overlapped with each other with a predetermined range of frequency band.

By calculating a time until sound wave signals used in the sound wave detection device 400 are emitted toward an object and hit and echo the object, a distance between the vehicle and the object is measured, and a time until the sound wave signal is emitted, echoed, and received may be referred to as a search period.

In an embodiment, the sound wave detection device 400 may use the n number of sound wave signals to detect an object, and each sound signal may be configured so that interference does not occur with different frequency bands.

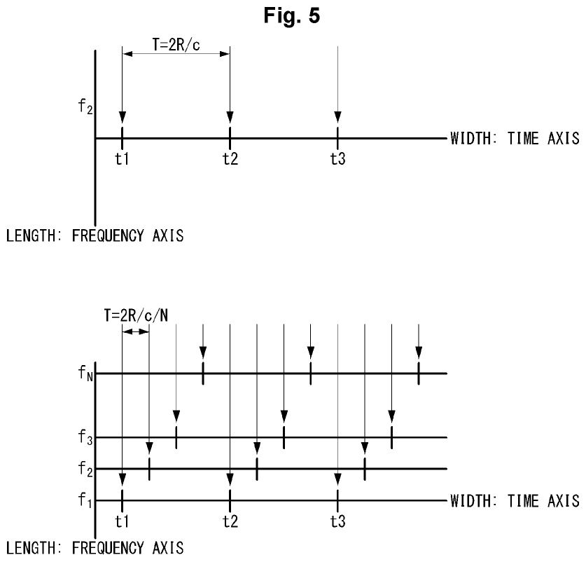

FIG. 5(A) illustrates a search period of a case (hereinafter, a comparative example) of using a single sound wave signal, and FIG. 5(B) illustrates a search period of a case (hereinafter, an embodiment) of using the n number of sound wave signals. Here, a search period T is a time until a sound wave is transmitted and an echoed sound wave is received and may be defined as a value obtained by dividing a value obtained by doubling a maximum detection distance R by a sound speed C.

First, in a comparative example A, when it is assumed that a sound wave signal f1 is emitted at a time t1, the search period T of the sound wave signal f1 is 2R/C. For example, when a maximum detection distance is 340 m/sec, a sound velocity C is also 340 m/sec in the air, so that the search period T may be 2 seconds.

In an embodiment B, unlike a comparative example, it may be configured to search for an object using the n number of sound wave signals f1 to fn. It is preferable that each of the sound wave signals uses different frequency signals so that frequency interference does not occur. Here, the signal has a frequency band of a predetermined range, and the frequency may be a center frequency. Accordingly, in an embodiment, because interference between signals does not occur, even if the n number of signals are used, sound waves may be accurately detected. Here, n is a natural number and may be differently determined according to an applied device. When being applied to a slow artificial intelligence robot, n may be smaller than that when being applied to a high-speed autonomous vehicle.

After the first sound wave signal f1 is emitted, it is preferable that a second sound wave signal f2 is emitted in a search period 2R/C of the first sound wave signal, and more preferably, when the number of used frequencies is n, it is preferable to emit a sound wave signal to correspond to a period in which a search period of the first sound wave signal f1 is divided into n. Accordingly, in the embodiment, because an actual search period T is 2R/c/N, a search period of an embodiment is 2/n (sec) under the same condition as that of a comparative example and thus a search period of an embodiment is more effectively reduced than that of the comparative example. Accordingly, the sound wave signal may be used for detecting an object in the autonomous vehicle moving at a high speed.

Further, in an autonomous vehicle, when an object is detected by sound waves, the following effects may be expected.

When peripheral search is performed by sound waves in the autonomous vehicle, animals sensitive to a sound can be prevented in advance from colliding with the autonomous vehicle.

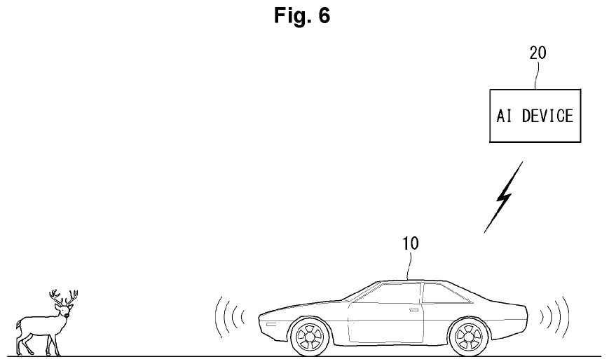

Referring to FIG. 6, an autonomous vehicle 10 may control a sound wave detection unit 290 in order to detect a periphery while driving a road to emit a sound wave signal having a search period of 2R/c/N through a front surface and a rear surface of the autonomous vehicle, and measure a distance between the autonomous vehicle 10 and an object through an echo signal echoed and received from the object, and the measured distance information may be input to an autonomous driving module 260 to be reflected to an operation of the autonomous vehicle.

Therefore, because the autonomous vehicle emits a sound wave signal with a search period of 2R/c/N in a driving direction of the vehicle, if there is an animal on a driving route, the animal may react to a sound wave to safely escape from the driving route of the autonomous vehicle, and animals out of the driving route do not enter the driving route due to sound waves, so that an accident can be prevented in advance.

Hereinafter, an autonomous vehicle having a sound wave detection device will be described.

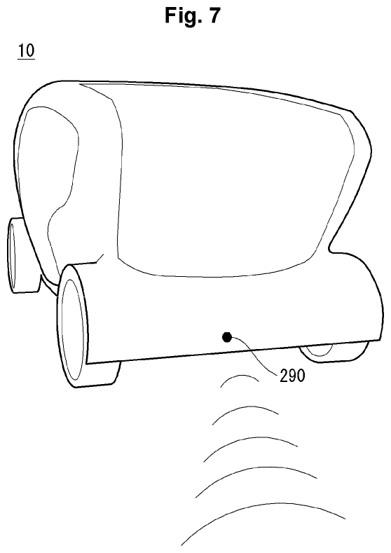

FIG. 7 is a diagram illustrating a vehicle according to an embodiment of the present invention.

Referring to FIG. 7, a vehicle 10 according to an embodiment of the present invention is defined as a transport means driving on a road or a track. The vehicle 10 is a concept including a car, a train, and a motorcycle. The vehicle 10 may be a concept including all of an internal combustion vehicle having an engine as a power source, a hybrid vehicle having an engine and an electric motor as a power source, and an electric vehicle having an electric motor as a power source. The vehicle 10 may be a privately owned vehicle. The vehicle 10 may be a shared vehicle. The vehicle 10 may be an autonomous vehicle.

Such a vehicle may include a sound wave detection unit 290 configured with the above-described sound wave detection device. The sound wave detection unit 290 may emit sound waves onto a driving route while the vehicle drives and generate distance information between the vehicle and an object through sound waves echoed by colliding with the object. In this case, the number of sound wave signals emitted from the vehicle is n, and sound wave signals having a search period of 2R/c/N are emitted to detect an object.

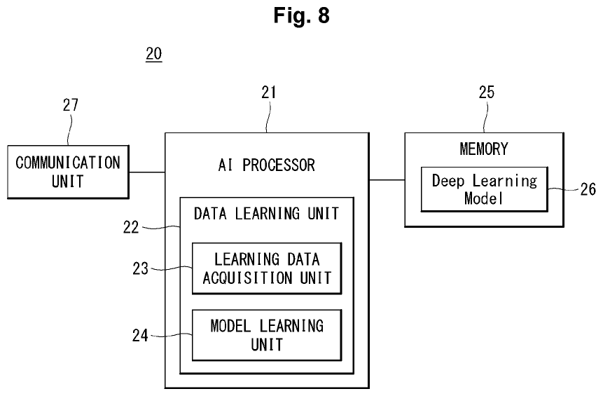

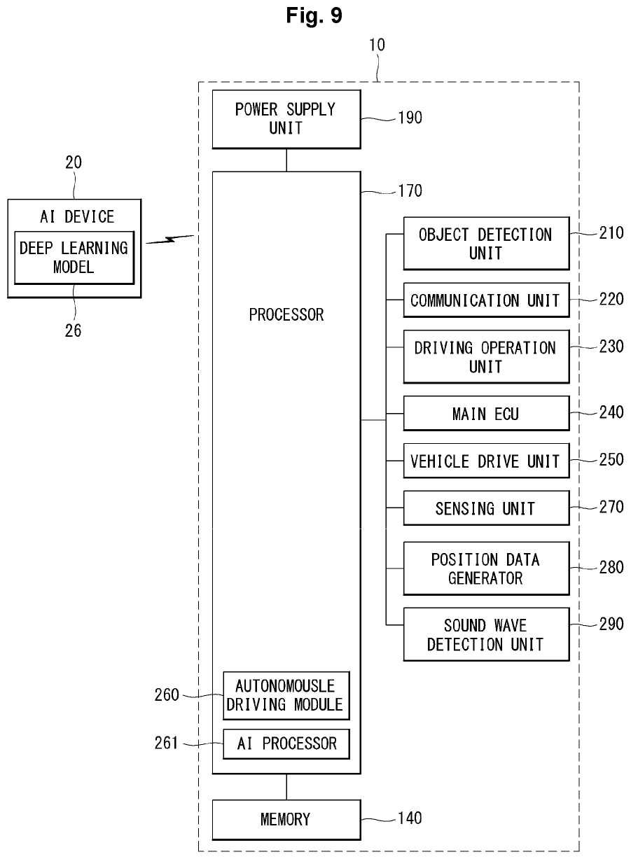

FIG. 8 is a block diagram illustrating an AI device according to an embodiment of the present invention.

An AI device 20 may include electronic equipment including an AI module that may perform AI processing or a server including the AI module. Further, the AI device 20 may be included in at least some configurations of the vehicle 10 of FIG. 7 to together perform at least some of AI processing.

The AI processing may include all operations related to driving of the vehicle 10 of FIG. 7. For example, the autonomous vehicle may perform AI processing of sensing data or driver data to perform processing/determination and control signal generation operations. Further, for example, the autonomous vehicle may perform AI processing of data obtained through an interaction with other electronic device provided in the vehicle to perform the autonomous driving control.

The AI device 20 may include an AI processor 21, a memory 25 and/or a communication unit 27.

The AI device 20 is a computing device capable of learning a neural network and may be implemented into various electronic devices such as a server, a desktop PC, a notebook PC, and a tablet PC.

The AI processor 21 may learn a neural network using a program stored in the memory 25. In particular, the AI processor 21 may learn a neural network for recognizing vehicle related data. Here, a neural network for recognizing vehicle related data may be designed to simulate a human brain structure on a computer and include a plurality of network nodes having a weight and simulating a neuron of the human neural network. The plurality of network modes may exchange data according to each connection relationship so as to simulate a synaptic activity of neurons that send and receive signals through a synapse. Here, the neural network may include a deep learning model developed in a neural network model. In the deep learning model, while a plurality of network nodes is located in different layers, the plurality of network nodes may send and receive data according to a convolution connection relationship. An example of the neural network model includes various deep learning techniques such as deep neural networks (DNN), convolutional deep neural networks (CNN), Recurrent Boltzmann Machine (RNN), Restricted Boltzmann Machine (RBM), deep belief networks (DBN), and a deep Q-network and may be applied to the field of computer vision, speech recognition, natural language processing, and voice/signal processing.

A processor for performing the above-described function may be a general-purpose processor (e.g., CPU), but may be an AI dedicated processor (e.g., GPU) for learning AI.

The memory 25 may store various programs and data necessary for an operation of the AI device 20. The memory 25 may be implemented into a non-volatile memory, a volatile memory, a flash memory, a hard disk drive (HDD), or a solid state drive (SDD) and the like. The memory 25 may be accessed by the AI processor 21 and read/write/modify/delete/update of data may be performed by the AI processor 21. Further, the memory 25 may store a neural network model (e.g., a deep learning model 26) generated through learning algorithm for data classification/recognition according to an embodiment of the present invention.

The AI processor 21 may include a data learning unit 22 for learning a neural network for data classification/recognition. The data learning unit 22 may learn learning data to use in order to determine data classification/recognition and a criterion for classifying and recognizing data using learning data. By obtaining learning data to be used for learning and applying the obtained learning data to a deep learning model, the data learning unit 22 may learn a deep learning model.

The data learning unit 22 may be produced in at least one hardware chip form to be mounted in the AI device 20. For example, the data learning unit 22 may be produced in a dedicated hardware chip form for artificial intelligence (AI) and may be produced in a part of a general-purpose processor (CPU) or a graphic dedicated processor (GPU) to be mounted in the AI device 20. Further, the data learning unit 22 may be implemented into a software module. When the data learning unit 22 is implemented into a software module (or program module including an instruction), the software module may be stored in non-transitory computer readable media. In this case, at least one software module may be provided by an Operating System (OS) or may be provided by an application.

The data learning unit 22 may include a learning data acquisition unit 23 and a model learning unit 24.

The learning data acquisition unit 23 may obtain learning data necessary for a neural network model for classifying and recognizing data. For example, the learning data acquisition unit 23 may obtain vehicle data and/or sample data for inputting as learning data to the neural network model.

The model learning unit 24 may learn to have a determination criterion in which a neural network model classifies predetermined data using the obtained learning data. In this case, the model learning unit 24 may learn a neural network model through supervised learning that uses at least a portion of the learning data as a determination criterion. Alternatively, the model learning unit 24 may learn a neural network model through unsupervised learning that finds a determination criterion by self-learning using learning data without supervision. Further, the model learning unit 24 may learn a neural network model through reinforcement learning using feedback on whether a result of situation determination according to learning is correct. Further, the model learning unit 24 may learn a neural network model using learning algorithm including error back-propagation or gradient decent.

When the neural network model is learned, the model learning unit 24 may store a learned neural network model in the memory 25. The model learning unit 24 may store the learned neural network model at the memory of the server connected to the AI device 20 by a wired or wireless network.

In order to improve an analysis result of a recognition model or to save a resource or a time necessary for generation of the recognition model, the data learning unit 22 may further include a learning data pre-processor (not illustrated) and a learning data selection unit (not illustrated).

The learning data pre-processor may pre-process obtained data so that the obtained data may be used in learning for situation determination. For example, the learning data pre-processor may process the obtained data in a predetermined format so that the model learning unit 24 uses obtained learning data for learning for image recognition.

Further, the learning data selection unit may select data necessary for learning among learning data obtained from the learning data acquisition unit 23 or learning data pre-processed in the pre-processor. The selected learning data may be provided to the model learning unit 24. For example, by detecting a specific area of an image obtained through a camera of a vehicle, the learning data selection unit may select only data of an object included in the specified area as learning data.

Further, in order to improve an analysis result of the neural network model, the data learning unit 22 may further include a model evaluation unit (not illustrated).

The model evaluation unit inputs evaluation data to the neural network model, and when an analysis result output from evaluation data does not satisfy predetermined criteria, the model evaluation unit may enable the model learning unit 22 to learn again. In this case, the evaluation data may be data previously defined for evaluating a recognition model. For example, when the number or a proportion of evaluation data having inaccurate analysis results exceeds a predetermined threshold among analysis results of a learned recognition model of evaluation data, the model evaluation unit may evaluate evaluation data as data that do not satisfy predetermined criteria.

The communication unit 27 may transmit an AI processing result by the AI processor 21 to an external electronic device.

Here, the external electronic device may be defined as an autonomous vehicle. Further, the AI device 20 may be defined to another vehicle or a 5G network communicating with the autonomous module vehicle. The AI device 20 may be implemented with functionally embedded in the autonomous module provided in the vehicle. Further, the 5G network may include a server or a module for performing the autonomous driving related control.

It has been described that the AI device 20 of FIG. 8 is functionally divided into the AI processor 21, the memory 25, and the communication unit 27, but the above-mentioned elements may be integrated into a single module to be referred to as an AI module.

FIG. 9 is a diagram illustrating a system in which an autonomous vehicle and an AI device are connected according to an embodiment of the present invention.

Referring to FIG. 9, the autonomous vehicle 10 may transmit data requiring AI processing to the AI device 20 through the communication unit, and the AI device 20 including the deep learning model 26 may transmit the AI processing result using the deep learning model 26 to the autonomous vehicle 10. The AI device 20 may refer to the contents described in FIG. 8.

The autonomous vehicle 10 may include a memory 140, a processor 170, and a power supply unit 190, and the processor 170 may further include an autonomous driving module 260 and an AI processor 261. Further, the autonomous vehicle 10 may include an interface unit connected to at least one electronic device provided in the vehicle by a wired or wireless means to exchange data required for the autonomous driving control. At least one electronic device connected through the interface unit may include an object detection unit 210, a communication unit 220, a driving operation unit 230, a main ECU 240, a vehicle drive unit 250, a sensing unit 270, a position data generator 280, and a sound wave detection unit 290 configured with the above-described sound wave detection device.

The interface unit may be configured with at least one of a communication module, a terminal, a pin, a cable, a port, a circuit, an element, and a device.

The memory 140 is electrically connected to the processor 170. The memory 140 may store basic data of a unit, control data for controlling an operation of the unit, and input and output data. The memory 140 may store data processed by the processor 170. The memory 140 may be configured with at least one of a read-only memory (ROM), a random-access memory (RAM), an erasable programmable read only memory (EPROM), a flash drive, and a hard drive in hardware. The memory 140 may store various data for overall operations of the autonomous vehicle 10, such as a program for processing or controlling the processor 170. The memory 140 may be implemented integrally with the processor 170. According to an embodiment, the memory 140 may be classified into a subcomponent of the processor 170.

The power supply unit 190 may supply power to the autonomous vehicle 10. The power supply unit 190 may receive power from a power source (e.g., battery) included in the autonomous vehicle 10 and supply power to each unit of the autonomous vehicle 10. The power supply unit 190 may operate according to a control signal supplied from the main ECU 240. The power supply unit 190 may include a switched-mode power supply (SMPS).

The processor 170 may be electrically connected to the memory 140, the interface unit 280, and the power supply unit 190 to exchange a signal. The processor 170 may be implemented using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electrical units for performing other functions.

The processor 170 may be driven by power supplied from the power supply unit 190. The processor 170 may receive and process data, and generate and provide a signal in a state in which power is supplied by the power supply unit 190.

The processor 170 may receive information from other electronic device within the autonomous vehicle 10 through an interface unit. The processor 170 may provide a control signal to other electronic devices within the autonomous vehicle 10 through the interface unit.

The autonomous vehicle 10 may include at least one printed circuit board (PCB). The memory 140, the interface unit, the power supply unit 190, and the processor 170 may be electrically connected to a printed circuit board.

Hereinafter, the AI processor 261, the autonomous driving module 260, and other electronic devices within the vehicle connected to the interface unit will be described in more detail. Hereinafter, for convenience of description, the autonomous vehicle 10 will be referred to as a vehicle 10.

First, the object detection unit 210 may generate information on an external object of the vehicle 10. The AI processor 261 may apply a neural network model to data obtained through the object detection unit 210, thereby determining whether an object exists, position information of the object, and what is the object.

The object detection unit 210 may include at least one sensor capable of detecting an external object of the vehicle 10. The sensor may be a camera. The object detection unit 210 may provide data on an object generated based on a sensing signal generated by a sensor to at least one electronic device included in the vehicle.

The vehicle 10 may transmit data obtained through the sensor to the AI device 20 through the communication unit 220, and by applying a neural network model 26 to the transmitted data, the AI device 20 may transmit the generated AI processing data to the vehicle 10. The vehicle 10 may recognize information on a detected object based on the received AI processing object data, and the autonomous driving module 260 may perform an autonomous driving control operation using the recognized information. Further, the autonomous driving module 260 may combine distance information between the vehicle and an object generated in the sound wave detection unit 290 to be described later with AI processing data to perform a more accurate autonomous driving control operation.

The communication unit 220 may exchange signals with a device located outside the vehicle 10. The communication unit 220 may exchange signals with at least one of an infrastructure (e.g., server, broadcasting station), other vehicle, and a terminal. The communication unit 220 may include at least one of a transmission antenna and a reception antenna for performing communication, and a Radio Frequency (RF) circuit and an RF device capable of implementing various communication protocols.

The driving operation unit 230 is a device for receiving a user input for driving. In a manual mode, the vehicle 10 may be driven based on a signal provided by the driving operation unit 230. The driving operation unit 230 may include a steering input device (e.g., steering wheel), an acceleration input device (e.g., accelerator pedal), and a brake input device (e.g., brake pedal).

The AI processor 261 may generate an input signal of the driving operation unit 230 according to a signal for controlling a movement of the vehicle according to a driving plan generated through the autonomous driving module 260 in an autonomous driving mode. When generating a driving plan, the autonomous driving module 260 may refer to distance information between the vehicle and an object generated in the sound wave detection unit 290 to more accurately control the vehicle.

The vehicle 10 may transmit data necessary for controlling the driving operation unit 230 to the AI device 20 through the communication unit 220, and the AI device 20 may apply the neural network model 26 to the transmitted data to transmit generated AI processing data to the vehicle 10. The vehicle 10 may use an input signal of the driving operation unit 230 for the motion control of the vehicle based on the received AI processing data.

The main ECU 240 may control overall operations of at least one electronic device provided in the vehicle 10.

The vehicle drive unit 250 is a device for electrically controlling various vehicle drive devices in the vehicle 10. The vehicle drive unit 250 may include a power train drive control device, a chassis drive control device, a door/window drive control device, a safety device drive control device, a lamp drive control device, and an air conditioning drive control device. The power train drive control device may include a power source drive control device and a transmission drive control device. The chassis drive control device may include a steering drive control device, a brake drive control device, and a suspension drive control device. The safety drive control device may include a safety belt drive control device for controlling a safety belt.

The vehicle drive unit 250 includes at least one electronic control device (e.g., electronic control unit (ECU)).

The vehicle drive unit 250 may control the power train, the steering device, and the brake device based on signals received in the autonomous driving module 260. A signal received from the autonomous driving module 260 may be a drive control signal generated by applying vehicle related data to a neural network model in the AI processor 261. The drive control signal may be a signal received from an external AI device 20 through the communication unit 220.

The sensing unit 270 may sense a status of the vehicle. The sensing unit 270 may include at least one of an inertial measurement unit (IMU) sensor, a collision sensor, a wheel sensor, a speed sensor, a tilt sensor, a weight detection sensor, a heading sensor, a position module, a vehicle forward/reverse sensor, a battery sensor, a fuel sensor, a tire sensor, a steering sensor, a temperature sensor, a humidity sensor, an ultrasonic sensor, an illuminance sensor, and a pedal position sensor. The IMU sensor may include at least one of an acceleration sensor, a gyro sensor, and a magnetic sensor.

By applying a neural network model to sensing data sensed by the at least one sensor, the AI processor 261 may generate status data of the vehicle. AI processing data generated by applying the neural network model may include vehicle posture data, vehicle motion data, vehicle yaw data, vehicle roll data, vehicle pitch data, vehicle collision data, vehicle direction data, vehicle angle data, vehicle speed data, vehicle acceleration data, vehicle tilt data, vehicle forward/reverse data, vehicle weight data, battery data, fuel data, tire air pressure data, vehicle interior temperature data, vehicle interior humidity data, steering wheel rotation angle data, vehicle exterior illuminance data, pressure data applied to an accelerator pedal, pressure data applied to a brake pedal, and the like.

The autonomous driving module 260 may generate a driving control signal based on status data of the AI processed vehicle.

The vehicle 10 may transmit sensing data obtained through at least one sensor to the AI device 20 through the communication unit 220, and by applying the neural network model 26 to the transmitted sensed data, the AI device 20 may transmit the generated AI processing data to the vehicle 10.

The position data generator 280 may generate position data of the vehicle 10. The position data generator 280 may include at least one of a Global Positioning System (GPS) and a Differential Global Positioning System (DGPS).

By applying the neural network model to position data generated in at least one position data generator, the AI processor 261 may generate more accurate vehicle position data.

According to an embodiment, the AI processor 261 may perform a deep learning operation based on at least one of an Inertial Measurement Unit (IMU) of the sensing unit 270, a camera image of the object detection unit 210, and distance information of the sound wave detection unit 290 and correct position data based on the generated AI processing data.

The sound wave detection unit 290 may operate to transmit a plurality of sound wave signals in a driving direction of the vehicle and to receive echoed sound wave signals by hitting the object and to generate distance information between the vehicle and the object. A configuration of the sound wave detection unit 290 may refer to the description of FIGS. 4 to 6.

The vehicle 10 may include an internal communication system 50. A plurality of electronic devices included in the vehicle 10 may exchange signals via the internal communication system 50. The signal may include data. The internal communication system 50 may use at least one communication protocol (e.g., CAN, LIN, FlexRay, MOST, Ethernet).

The autonomous driving module 260 may generate a path for autonomous driving based on the obtained data and generate a driving plan for driving along the generated path.

The autonomous driving module 260 may implement at least one Advanced Driver Assistance System (ADAS) function. The ADAS may implement at least one of Adaptive Cruise Control (ACC), Autonomous Emergency Braking (AEB), Forward Collision Warning (FCW), Lane Keeping Assist (LKA), Lane Change Assistant (LCA), Target Following Assist (TFA), Blind Spot Detection (BSD), High Beam Assist (HBA), Auto Parking System (APS), PD collision warning system, Traffic Sign Recognition (TSR), Traffic Sign Assist (TSA), Night Vision (NV), Driver Status Monitoring (DSM), and Traffic Jam Assist (TJA).

The AI processor 261 may apply traffic related information received from an external device and at least one sensor provided in the vehicle and information received from other vehicles communicating with the vehicle to the neural network model to transfer a control signal that may perform the above at least one ADAS function to the autonomous driving module 260.

Further, the vehicle 10 may transmit at least one data for performing ADAS functions to the AI device 20 through the communication unit 220, and by applying the neural network model 26 to the received data, the AI device 20 may transmit a control signal that may perform the ADAS function to the vehicle 10.

The autonomous driving module 260 may obtain the driver's status information and/or status information of the vehicle through the AI processor 261, and perform a switching operation from an autonomous driving mode to a manual driving mode or a switching operation from a manual driving mode to an autonomous driving mode based on the information.

The vehicle 10 may use AI processing data for the passenger support to the driving control. For example, as described above, a status of the driver and the passenger may be determined through at least one sensor provided in the vehicle.

Alternatively, the vehicle 10 may recognize a voice signal of a driver or an occupant through the AI processor 261, perform a voice processing operation, and perform a voice synthesis operation.

The sound wave detection unit 290 may include a transmission module for transmitting a plurality of sound wave signals, a reception module for receiving echoed sound wave signals among the sound wave signals, a signal generation module for generating a plurality of sound wave signals having different frequencies, and a control module for emitting a first sound wave signal of the plurality of sound wave signals and transmitting a second sound wave signal having a frequency different from that of the first sound wave signal through the transmitter in a search period of the first sound wave signal, and a description of each module is substantially the same as that described with reference to FIGS. 4 to 6, and therefore, the above description may be referred to.

In the following description, an embodiment has been described in which a sound wave detection device is installed in an autonomous vehicle having artificial intelligence, but the present invention is not limited thereto and is similarly implemented in an electronic device equipped with artificial intelligence, such as a robot cleaner and a robot to operate to generate distance information between the electronic device and an object.

The present invention may be implemented as a computer readable code in a program recording medium. The computer readable medium includes all kinds of record devices that store data that may be read by a computer system. The computer readable medium may include, for example, a Hard Disk Drive (HDD), a Solid State Disk (SSD), a Silicon Disk Drive (SDD), a read-only memory (ROM), a random-access memory (RAM), a compact disc read-only memory (CD-ROM), a magnetic tape, a floppy disk, an optical data storage device and the like and also include a medium implemented in the form of a carrier wave (e.g., transmission through Internet). Accordingly, the detailed description should not be construed as being limitative from all aspects, but should be construed as being illustrative. The scope of the present invention should be determined by reasonable analysis of the attached claims, and all changes within the equivalent range of the present invention are included in the scope of the present invention.

1. A sound wave detection device, comprising:
a signal generator for generating a plurality of sound wave signals having different frequencies;
a transmitter for transmitting the plurality of sound wave signals;
a receiver for receiving an echoed sound wave signal among the sound wave signals; and
a controller for emitting a first sound wave signal of the plurality of sound wave signals and transmitting a second sound wave signal having a frequency different from that of the first sound wave signal through the transmitter in a search period of the first sound wave signal,
wherein the search period is a value obtained by dividing a value obtained by doubling a maximum detection distance by a sound speed.

2. The sound wave detection device of claim 1, wherein the first sound wave signal has a center frequency of a first frequency band, and the second sound wave signal has a center frequency of a second frequency band that does not overlap with the first frequency band.

3. The sound wave detection device of claim 1, wherein the number of the plurality of sound wave signals is n,
wherein the n number of sound wave signals have different frequencies, and
wherein the controller transmits each of the n number of sound wave signals to correspond to a period in which the search period is divided into 1/n.

4. An electronic device in which artificial intelligence is installed, the electronic device comprising:
a sound wave detection unit for detecting a peripheral object with a sound wave,
wherein the sound wave detection unit comprises:
a signal generation module for generating a plurality of sound wave signals having different frequencies;
a transmission module for transmitting the plurality of sound wave signals;
a reception module for receiving an echoed sound wave signal among the sound wave signals; and
a control module for emitting a first sound wave signal of the plurality of sound wave signals and transmitting a second sound wave signal having a frequency different from that of the first sound wave signal through the transmitter in a search period of the first sound wave signal,
wherein the search period is a value obtained by dividing a value obtained by doubling a maximum detection distance by a sound speed.

5. The electronic device of claim 4, wherein the first sound wave signal has a center frequency of a first frequency band, and the second sound wave signal has a center frequency of a second frequency band that does not overlap with the first frequency band.

6. The electronic device of claim 4, wherein the number of the plurality of sound wave signals is n,
wherein the n number of sound wave signals have different frequencies, and
wherein the controller transmits each of the n number of sound wave signals to correspond to a period in which the search period is divided into 1/n.
